(19) United States
(12) Patent Application Publication
(10) Pub. No.: US 2024/0353585 A1
(43) Pub. Date: Oct. 24, 2024

(54) ADAPTIVE AQUATIC SEISMIC WHILE DRILLING ACQUISITION METHODS AND SYSTEMS

(71) Applicant: SAUDI ARABIAN OIL COMPANY, Dhahran (SA)

(72) Inventors: Ali ALDAWOOD, Ras Tanura (SA); Mohammed ALMARZOUG, Dhahran (SA)

(73) Assignee: SAUDI ARABIAN OIL COMPANY, Dhahran (SA)

(21) Appl. No.: 18/303,437

(22) Filed: Apr. 19, 2023

(51) Int. Cl. G01V 1/38; E21B 3/02; G01V 1/143

(52) U.S. Cl. CPC G01V 1/3852; E21B 3/022; G01V 1/143

(57) ABSTRACT

A method includes drilling a borehole in a seafloor with a drill bit coupled to an end of a drill string extended from a drilling rig, emitting seismic energy from the drill bit as the drill bit advances to extend the borehole, deploying a plurality of autonomous underwater vehicles (AUVs) on the seafloor in a first geometry relative to the borehole, each AUV including a seismic receiver, and receiving the seismic energy emitted from the drill bit with the seismic receiver of each AUV.

### FIELD OF THE DISCLOSURE

The present disclosure relates generally to obtaining seismic while drilling (SWD) data in an aquatic environment and, more particularly, to systems and methods of obtaining adaptive SWD data utilizing autonomous underwater vehicles (AUVs).

### BACKGROUND OF THE DISCLOSURE

Marine or aquatic seismic data obtained during drilling operations provide information regarding the status of the drilling operation and the geophysical structure beneath the seafloor, including any hydrocarbon-bearing subterranean formations. In marine exploration geophysics, seismic sources and sensors are used in different geometries to acquire data for specific purposes. For example, vertical seismic profiling (VSP) data are conventionally acquired to obtain time-depth curves and velocity information around the well. For VSP data, seismic sources are commonly attached to a survey ship at a certain offset from a well, and seismic receivers are placed inside the borehole of the well. In reverse vertical seismic profiling (rVSP), the receivers are attached to the survey ship at a certain offset from a well and the seismic sources are deployed inside the borehole of the well.

VSP data can be acquired with different geometries of seismic sources and receivers, such as zero-offset VSP (ZVSP), walkaway (WAVSP), and walkaround (WAR) VSP. ZVSP is a geometry in which data are acquired by placing the seismic source in close proximity to the borehole of the well in which the receiver is positioned. ZVSP data are used to construct a subsurface 1D velocity profile. A more advanced geometry, such as WAVSP, deploys seismic sources in a 2D line passing through the well location to obtain data that can be used to generate 2D seismic images of the subsurface formation in the area of the well. WAR VSP data are obtained by positioning a plurality of seismic sources in a circle around the borehole of the well to provide constant angles between the multiple seismic sources and a receiver inside the borehole. WAR VSP data can, for example, provide azimuthal subsurface velocity information and fracture characterization of the reservoir.

While VSP data can provide very good data regarding the drilling operation and the subsurface geophysical structure, acquiring VSP data can be quite costly and require drilling operation intervention during data collection and the invasive insertion of the downhole receivers to record seismic data, which requires extra rig time and expense.

Seismic while drilling (SWD) acquisition systems are an alternative to VSP systems that utilize the drill bit noise as a seismic source and the seismic signal from the drill bit noise is recorded at receiver stations on the seafloor. SWD data acquisition systems eliminate the need to interfere with the rig operations during data acquisition and the need to deploy separate surface seismic sources and receivers. This approach saves the cost associated with additional rig time needed to install downhole receivers or seismic sources.

SWD acquisition systems resemble an rVSP geometry with the downhole source being the drill bit and the seismic receivers positioned on the seafloor. During SWD data acquisition, a top-drive sensor on the rig records vibration energy from the drill string, including drill bit noise signatures vibrating through the drill string, and that data is used to deconvolve the drill bit noise and collapse the noise into an impulse-like signal. A challenge when acquiring SWD data is determining the location closest to the well to place a seismic receiver as a ZVSP and to thereby construct a 1D velocity profile. Additionally, there can be significant costs in time and manpower in deploying and recovering seismic receivers.

Autonomous underwater vehicles (AUVs) have recently been developed for acquiring data in marine environments. AUVs can efficiently be deployed to and recovered from the seafloor by a surface vessel. Using AUVs to acquire wellbore data in marine environments reduces cost and risk associated with marine exploration since it can reduce the labor required to obtain such data.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method may include drilling a borehole in a seafloor with a drill bit coupled to an end of a drill string extended from a drilling rig, emitting seismic energy from the drill bit as the drill bit advances to extend the borehole, deploying a plurality of AUVs on the seafloor in a first geometry relative to the borehole, each AUV including a seismic receiver and receiving the seismic energy emitted from the drill bit with the seismic receiver of each AUV.

In another embodiment, a method may include drilling a borehole in a seafloor with a drill bit coupled to an end of a drill string extended from a drilling rig, emitting seismic energy from the drill bit as the drill bit advances to extend the borehole, deploying a plurality of AUVs on the seafloor in a walkaway geometry relative to the borehole, each AUV may include a seismic receiver. The method may further include receiving the seismic energy emitted from the drill bit with the seismic receiver of each AUV, recording seismic data corresponding to the seismic energy received by each seismic receiver while the plurality of AUVs are in the walkaway geometry, retrieving and analyzing the seismic data from the plurality of AUVs, and determining a walkaround geometry for the plurality of AUVs based on an analysis of the seismic data from the plurality of AUVs recorded while in the walkaway geometry. The method may further include deploying the plurality of AUVs on the seafloor in the walkaround geometry and receiving the seismic energy emitted from the drill bit with the seismic receiver of each AUV while the plurality of AUVs are in the walkaround geometry.

In another embodiment, a system may include a drilling rig having a drill bit coupled to a distal end of a drill string configured to drill a borehole in a seafloor and a plurality of AUVs each having a seismic receiver, the plurality of AUVs being configured to contact the seafloor and receive seismic data from the drill bit while drilling a borehole.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of an example method of acquiring SWD data in accordance with embodiments of the disclosure;

FIG. 2 is a schematic diagram of an example of a system for acquiring SWD data with AUVs in accordance with embodiments of the disclosure;

FIG. 3 is an enlarged side view of an example of a deployment geometry of an AUV relative to a borehole in accordance to embodiments of the disclosure;

FIG. 4A is an enlarged side view of an example drilling environment illustrating a deployment geometry of a plurality of AUVs relative to a borehole in accordance to embodiments of the disclosure;

FIG. 4B is a top view of the embodiment of FIG. 4A;

FIG. 5 is an enlarged top view of an example drilling environment illustrating another deployment geometry of a plurality of AUVs relative to a borehole in accordance to embodiments of the disclosure;

FIG. 6 is a representation of an exemplary rose diagram showing the orientation of fractures in a reservoir, as may be obtained by embodiments of the disclosure; and

FIG. 7 is a schematic representation of an exemplary AUV in accordance with embodiments of the disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

The present disclosure introduces a novel acquisition configuration for acquiring seismic while drilling (SWD) data in marine environments. SWD acquisition systems use the energy emitted from a drill bit as a seismic source, and the signal is recorded by sensors arranged on the seafloor. According to embodiments disclosed herein, autonomous underwater vehicles (AUVs) may be used as receiver nodes for acquiring seismic data. In one example, the AUVs may navigate to the seafloor to collect data with minimal intervention since the AUVs may be programmed or otherwise designed to operate simultaneously and autonomously. After data acquisition, the AUVs navigate back to where they were deployed.

The present disclosure proposes the acquisition of borehole seismic data by using noise emitted from an operating drill bit as a seismic source and the AUVs as receivers. The AUVs may be programmed and otherwise operable to change the data acquisition geometry adaptively based on the objective of the survey. For example, the AUVs may be deployed in a walkaway geometry on the seafloor to determine an offset that provides the best quality data. The AUV receiver nodes may then be reoriented in a walkaround geometry with the radius equal to the determined offset. Upon the drill bit reaching the reservoir, the nodes may be reconfigured to a larger radius appropriate for the depth of the reservoir. A pilot trace used for deconvoluting the acquired seismic data may be obtained from a GPS synchronized top-drive sensor installed on the associated drilling rig. The top-drive sensor may be configured to record the vibrations through the drill string as the drill bit is operating. In embodiments, the top-drive sensor may record drill bit vibrations that are conveyed through the drill string. The acquired seismic data can be used for multi-azimuthal velocity information and fractures analysis both in the reservoir and shallower sections of the wellbore.

Embodiments in accordance with the present disclosure generally relate to methods and systems for acquiring SWD data in an aquatic environment utilizing AUVs. An example of a method includes utilizing one or more AUVs to acquire SWD data while performing drilling operations with a drilling rig in an aquatic environment, including in marine and fresh water environments. Embodiments of the method include drilling a borehole for a well in a floor of an aquatic environment with a drilling rig, which is generally referred to herein as a seafloor. The term “seafloor” includes the floors of other aquatic environments, such as lakebeds, riverbeds, the ocean floor, and the like. The seismic energy from the drill bit serves as a seismic source for acquiring seismic data that can be analyzed to obtain information about the drilling operation, the subsurface formations, or both. The method also includes deploying one or more AUVs, each AUV having a seismic receiver, to contact the floor of the aquatic environment in a manner sufficient to receive seismic energy emitted from the operation of the drill bit. Embodiments of the system include a drill rig having a drill string coupled to a drill bit and one or more AUVs.

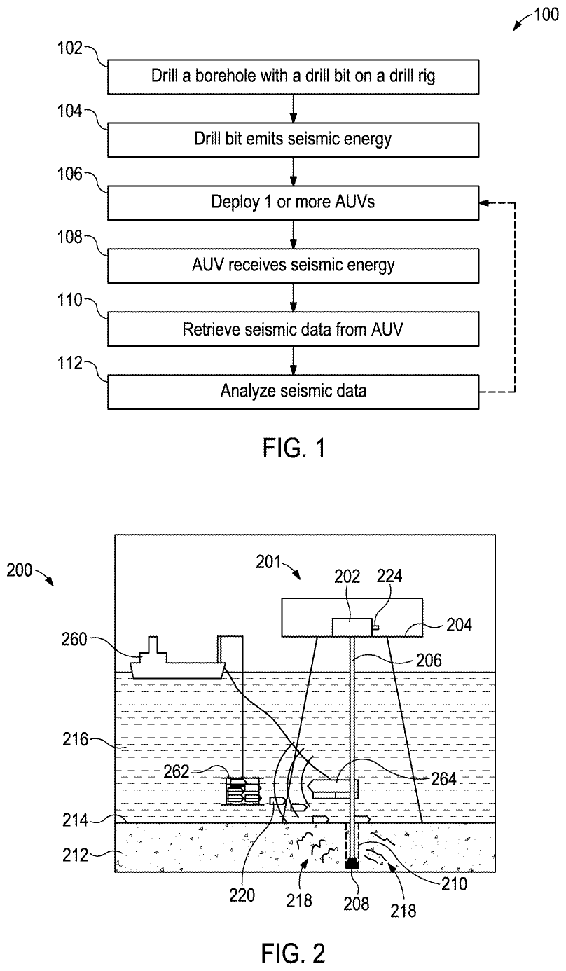

FIG. 1 is a block diagram of an example method 100 for acquiring SWD data while drilling a borehole into the floor of an aquatic environment 102. FIG. 2 is a non-limiting example of a system 200 for acquiring SWD data in accordance with the method 100. As shown in FIG. 2, the system 200 includes an offshore drilling rig 201, which includes a top drive 202 coupled to a platform 204, such as a floating or semi-submersible platform. The top drive 202 is operable to rotate a drill string 206, which includes a drill bit 208 coupled to its distal end. As the top drive 202 rotates the drill string 206, the drill bit 208 correspondingly rotates and progressively drills a borehole 210 for a well in a subterranean or subsurface formation 212 below the seafloor 214 of the aquatic environment 216. The interaction between the drill bit 208 and the subsurface formation 212 results in the emission or propagation of seismic energy 218 by the drill bit 208.

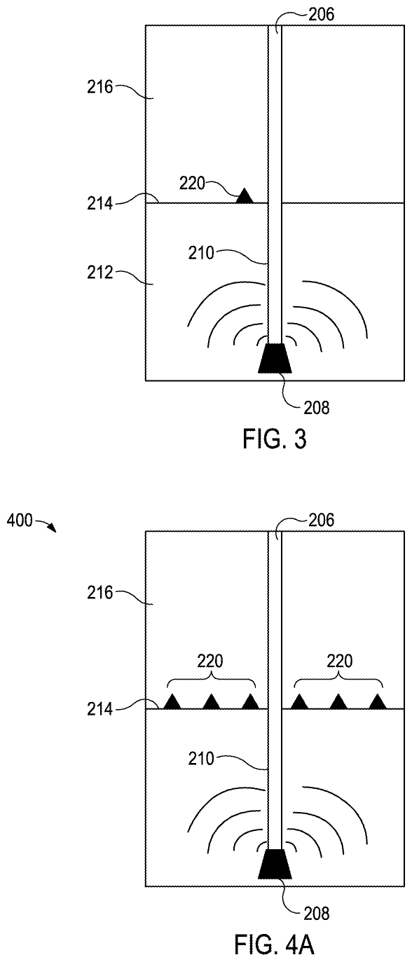

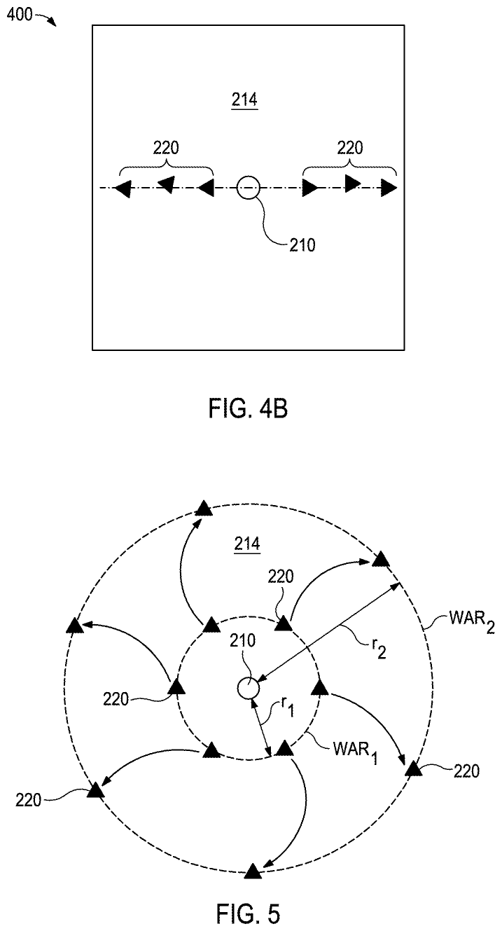

The system 100 may further include a plurality of autonomous underwater vehicles (AUV) 220 that include receiver nodes used to detect and receive the seismic energy 218. As illustrated, the AUVs 220 may be positioned in close proximity to the borehole 210 to obtain and detect the seismic energy 218. In at least one embodiment, the AUVs 220 may be arranged in a zero-offset geometry relative to the borehole 210, and the received data could be used to construct a subsurface 1D velocity profile. As used with respect to this embodiment, the term zero-offset geometry does not require the AUVs 220 to be strictly zero-offset from the borehole 210 of the drilling rig 201 as the AUVs 220 may need to be positioned at a safe distance from the rig 201 while drilling to allow data acquisition during drilling operations. An example of an AUV 220 in a zero-offset configuration being near the borehole 210 but not strictly zero-offset is shown in FIG. 3. In other embodiments, and in accordance with the principles of the present disclosure, the AUVs 220 may be deployed and otherwise arranged in more advanced geometries relative to the borehole 210, such as in a walkaway geometry, as shown in FIGS. 4A and 4B, or a walkaround geometry, as shown in FIG. 5.

The AUVs 220 may be deployed from a surface vessel 260, but could alternatively be deployed from the drilling rig 201. In an embodiment, the surface vessel 260 deploying the AUVs 220 launches the AUVs 220 in a pattern to result in the geometry needed for the seismic survey. Depending on the goal of the survey, the AUVs 220 may be instructed to propel themselves to one or more geometries of predetermined positions relative to the borehole 210 or relative to each other.

The AUVs 220 may propel themselves to the desired positions using a navigation system, such as an inertial navigation system using preprogrammed coordinates. However, in an embodiment, the AUVs 220 may find their desired positions using a combination of acoustic guidance, waypoint navigation and information from various navigation sensors in the navigation system such as an inertial measurement unit, echo sounder, pressure gauge, etc. In embodiments, other systems or methods may be used to assist the AUVs 220 in navigating to their desired positions. Thus, the AUVs 220 may be preprogrammed or partially programmed to find their desired positions. If the AUVs 220 are partially programmed, the final details for finding the desired position may be received, for example, acoustically using an Ultra-Short Base Line (USBL) system, from the surface vessel 260 or an underwater remote operating vehicle (ROV) 264.

In an embodiment, the AUVs 220 may be carried to and from the surface in a basket 262 deployed by the surface vessel 260. When the basket 262 is in a relatively close proximity to the seafloor 214 of the aquatic environment 216, the AUVs 220 may be activated and launched from the basket 262 to deploy to their desired positions on the seafloor 214 of the aquatic environment 216. More specifically, the AUVs 220 may traverse a pre-programmed path or may rely on guidance or assistance from the vessel 260 or the underwater ROV 264 (or another vessel), such as may be communicated acoustically through a USBL or Super Short Base Line (SSBL) system. This underwater launching method requires the AUVs 220 to use less energy to reach their respective locations and simplifies AUV navigation. One of ordinary skill will appreciate that the underwater ROV 264 operated from the surface vessel 264 may also carry the AUVs 220 to and from the surface in a manner similar to the basket 262.

In an embodiment, when selected AUVs 220 are instructed to leave their recording locations, they may be programmed to go to a desired rendezvous point where they will be recovered. The desired rendezvous point may be, for example, a recovery vessel, which may include the surface vessel 260, the drilling rig 201, the basket 262 lowered from the surface vessel 260 or the drilling rig 201, the underwater ROV 264, or any combination thereof. The recovery vessel may be configured to send acoustic signals to the returning AUVs 220 to guide them to the desired recovery location. When at the recovery location, the AUVs 220 may navigate directly into the recovery vessel or be loaded into the recovery vessel, such as by a robotic arm included in the surface vessel 260 or the underwater ROV 264.

The number of AUVs deployed in embodiments of the method will be dependent, in part, on the goal of the survey. In an exemplary embodiment, the number of AUVs deployed is in a range from about 100 to about 10,000. In another exemplary embodiment, the number of AUVs deployed is in a range from about 200 to about 5,000. In yet another embodiment, the number of AUVs deployed is in a range from about 500 to about 2,500. In yet another embodiment, the number of AUVs deployed is in a range from about 500 to about 2,000.

Referring again to FIG. 1, with continued reference to FIG. 2, the method 100 may include drilling the borehole 210 with the drill bit 208, as at 102. The method 100 may further include emitting the seismic energy 218 from the drill bit 208 as the drill bit 208 operates, as at 104. The method 100 may also include deploying the AUVs 220 into the aquatic environment, as at 106. The AUVs 220 may be deployed to contact the seafloor 214 in a predetermined geometry relative to the borehole 210 and based on the desired goal of the seismic survey. In embodiments consistent with step 106, the AUVs 220 may be deployed in a first geometry relative to the borehole 210 to acquire the seismic data.

After the AUVs 220 are properly placed on the seafloor 214, and while the drill bit 208 is drilling the borehole 210, the method 100 may further include receiving the seismic energy 218 emitted from the drill bit 208 with seismic receivers (receiver nodes) included in the AUVs 220, as at 108. The seismic energy 218 emitted from the drill bit 208 propagates in and through the subsurface formation 212. The velocity of the seismic energy 218 depends on the properties of the subsurface formation 212 including, but not limited to, density, porosity, and fluid content of the subsurface formation 212. Different layers of the subsurface formation 212 have different properties, thereby resulting in different seismic velocities. Consequently, seismic energy reflected back toward the surface when a boundary between two layers having different properties is encountered (e.g., sediment-basement interface or fracture) will include varying velocities representative of the boundary. The reflected seismic energy 218 is received by the seismic sensors in the AUVs 220, and the seismic energy 218 received by the seismic receiver of an AUV 220 is determined by the relative position of the AUV 220 compared to the seismic source (e.g., the drill bit 208).

The method 100 may further include retrieving the seismic data acquired by the seismic receivers of the AUVs 220, as at 110. In accordance with step 110, seismic data may be retrieved from the AUVs 220 that may have been acquired while the AUVs were arranged in the first geometry. In some embodiments, the seismic receivers record the seismic data relating to the received seismic energy to a recording medium included in the AUV 220, and the seismic data may subsequently be retrieved from the recording medium. For example, the AUVs 220 may be recovered by a recovery vessel, such as the surface vessel 260 (FIG. 2), and brought to a surface where the seismic data recorded on the recording media may be downloaded and analyzed. In at least one embodiment, the seismic data may be downloaded through a wired connection or through a wireless transmission. In other embodiments, however, the seismic data may be transmitted from the AUVs 220 to a remote receiver that records the data for further processing. The remote receiver may be located, for example, on a recovery vessel, the surface vessel 260, the underwater ROV 264, or the drilling rig 201.

The method 100 may then include analyzing the seismic data obtained by the AUVs 220, as at 112. As the AUVs 220 are arranged in different geometries relative to the borehole 210, the received seismic energy 218 may provide seismic data that can be analyzed to obtain information about the drilling process, the geometry of the subsurface formation 212, and any hydrocarbon-bearing reservoirs, for example. Accordingly, the retrieved seismic data may be analyzed to obtain the desired information about the drilling process or the subsurface formation 212.

In one or more embodiments, after the data acquired from AUVs 220 when arranged in the first geometry is retrieved, as at 110, and analyzed, as at 112, the method 100 may further include deploying the AUVs 220 to a second geometry based on the results of the analysis, as at 106, and indicated by the dashed line extending between 112 and 106. In a further embodiment of the method 100, the AUVs 220 may be deployed to a third geometry to obtain additional data. The first, second, and third geometries may be selected from the group consisting of a zero-offset geometry, a walkaway geometry, a walkaround geometry and three-dimensional seismic while drilling (3D SWD) geometry.

FIGS. 4A and 4B are enlarged side and top views of an example drilling environment 400 that may employ the principles of the present disclosure. The drilling environment 400 may form part of the system 200 of FIG. 2 and, therefore, may be best understood with reference thereto. As best seen in FIG. 4A, the drill string 206 and the drill bit 208 coupled to the distal end of the drill string 206 are extended through the aquatic environment 216 (FIG. 4A) and penetrate the seafloor 214 to begin the creation of the borehole 210. In one or more embodiments, the AUVs 220 may be deployed in a first geometry relative to the borehole 210 during the initial stages of the drilling operation. More specifically, the AUVs 220 may be arranged on the seafloor 214 relative to the borehole 210 in a walkaway geometry. In accordance with the walkaway geometry, the AUVs 220 are deployed in a generally linear manner (broken line) passing through the location of the borehole 210. The seismic energy 218 emitted by the drill bit 208 during operation may be received and recorded by the AUVs 220, thus resulting in obtained or acquired seismic data.

The seismic data acquired while in the walkaway geometry may be analyzed to determine, for example, the closest offset to the borehole 210 at which the best quality seismic data may be acquired. In some embodiments, the seismic data may be acquired while the AUVs 220 are in the walkaway geometry until the drilling operation reaches a first casing point in the borehole 210. More particularly, walkaway geometry seismic data may be obtained by the AUVs 220 until the depth of the borehole 210 reaches a point where a first string of casing is to be introduced into the borehole 210 and cemented into place. In such embodiments, the seismic data acquired while the AUVs 220 are in the first geometry (i.e., the walkaway geometry) may be retrieved from the AUVs 210 and analyzed while the drillers are setting the wellbore casing and otherwise during a pause in drilling operations.

Continuing with this example, the AUVs 220 may then be deployed on the seafloor 214 in a second geometry based on the analysis of the seismic data acquired while the AUVs 220 were in the first geometry. In this example, the AUVs 220 may be deployed in a walkaround geometry WAR₁ with a radius r₁ equivalent to the distance that resulted in the best quality data while the AUVs 220 were in the walkaway geometry.

FIG. 5 is an enlarged top view of the drilling environment 400, according to one or more additional embodiments of the disclosure. As illustrated, following deployment of the AUVs in the first or “walkaway” geometry, the AUVs 220 may then be deployed on the seafloor 214 in the second or “walkaround” geometry. More specifically, a first set of the AUVs 220 may be arranged in the walkaround geometry or “WAR₁” with a radius r₁, which may be equivalent to the measured distance resulting in the best quality data while the AUVs 220 were arranged in the walkaway geometry.

In the walkaround geometry, the AUVs 220 may be arranged in a generally circular geometry and concentric with the borehole 210. Once drilling operations resume, seismic data may then be acquired with the AUVs 220 in the first walkaround geometry WAR₁, which may resemble multi-azimuthal ZVSP data that can be analyzed for various applications, such as time-depth curves and azimuthal velocity information.

When the drilling operation is close to reaching or has reached total wellbore depth or the target reservoir, the AUVs 220 may then be moved and re-deployed to a second walkaround geometry or “WAR₂” having a radius r₂ that is different (e.g., larger) than the radius rₗ of the first walkaround geometry WAR₁. The radius r₂ of the second walkaround geometry WAR₂ positions the AUVs 220 at an appropriate offset from the borehole 210 to allow acquisition of data associated with, for example, the reservoir, and typically, the second radius r₂ will be greater than the first radius r₂. An exemplary use of the data acquired while in the second walkaround geometry WAR₂ is constructing rose diagrams that explain the orientation of fractures in the reservoir.

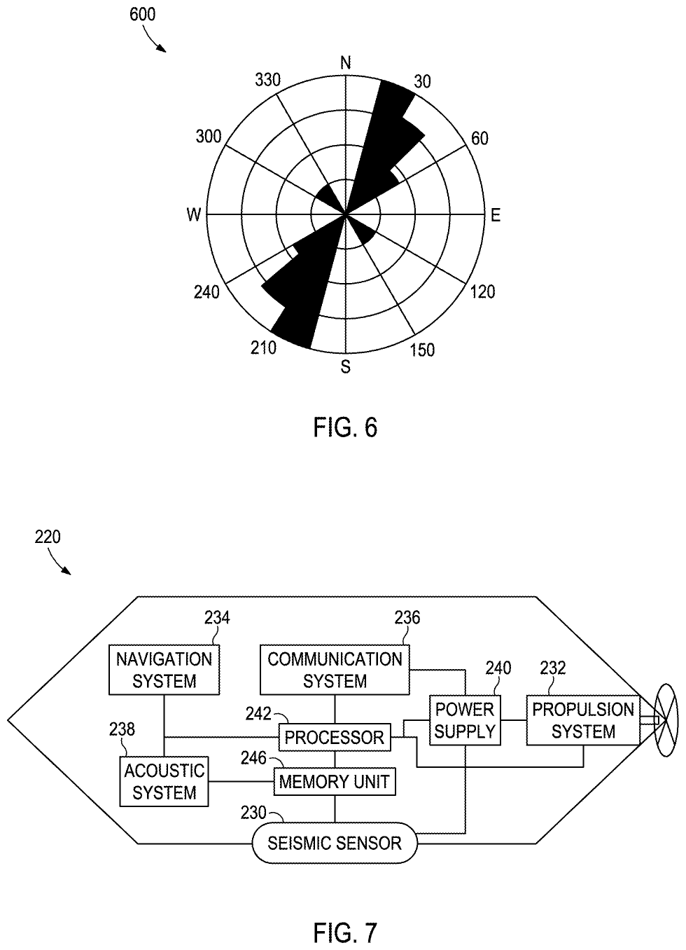

FIG. 6 is an example rose diagram 600 that shows the orientation of perceived fractures in the target reservoir based on the seismic data obtained by the AUVs in the first and second walkaround geometries WAR_{I}, WAR₂ positions (FIG. 5). In this diagram 600, the seismic data amplitude is plotted with respect to azimuth and areas near the center of the circle correspond to smaller amplitudes in the seismic data and areas closer to the circumference of the circle correspond to larger amplitudes in the seismic data. The black blocks correspond to the orientation of the fracture with the narrower the blocks providing a higher confidence estimation of the direction of the fracture orientation.

In an embodiment of the disclosure, the analysis of the seismic data received by the seismic receivers of the AUVs 220 includes processing the data to obtain information regarding the drilling operation, the geophysical subsurface formation, or both. Referring again to FIG. 2, in one or more embodiments, the top drive 202 may include one or more top drive sensors 224 (one shown) configured to record vibration energy created by the drill string 206, including noise signatures of the drill bit 208 vibrating through the drill string 206. More specifically, as the top drive 202 rotates the drill string 206, the top drive sensors 224 may be configured to measure axial, torsional, and transverse vibrations of the drill-string assembly. The vibration data from the top drive sensor 224 is recorded and used to deconvolve the noise generated by the drill bit 208 and collapse the noise into an impulse-like signal. This process is performed by using vibration data that results from the vibration energy received by the top drive sensor 224 as a deconvolution operator and applying a time shift that correspond to the vibrations time delays between the location of the top drive 202 and the subsurface location of the drill bit 208. Processing the seismic data to remove the vibration data obtained by the top drive sensor 224 allows the deconvolved seismic data to be used for a variety of purposes including, for example, for information regarding multi-azimuthal velocity and fractures analysis in both the reservoir and shallower sections. The processed seismic data may also be used to image both shallow and deep subsurface structures.

FIG. 7 is a schematic diagram of an example autonomous underwater vehicle (AUV) 220, according to one or more embodiments. Embodiments of the methods and systems described herein provide an inexpensive system for acquiring SWD data by deploying and recovering AUVs 220 that include seismic receivers for obtaining seismic data from the floor of an aquatic environment. According to an exemplary embodiment, such systems and methods include one or more AUVs 220, each having one or more seismic receivers. The AUV 220 depicted in FIG. 7 may be the same as or similar to any of the AUVs 220 of FIGS. 2, 3, 4A-4B, and 5, and may thus be used in the system 200 of FIG. 2 and the drilling environment 400 of FIGS. 4A-4B and 5. As illustrated, the AUV 220 may include a seismic receiver 230 configured to receive the seismic energy 218 (FIG. 2) emitted by the drill bit 208 (FIG. 2) and thereby obtain the seismic data. Examples of the seismic receiver 230 include, but are not limited to, a hydrophone, a geophone, an accelerometer, an electromagnetic sensor, a depth sensor, or a combination thereof.

The AUV 220 may also include a propulsion system 232, a navigation system 234, a communication system 236, an acoustic system 238, a power supply 240, and one or more processors 242 configured to control these systems and sensors. The AUV 220 may also include one or more memory units 246 capable of storing instructions for the operation of these systems and data from any of these systems as well as from the seismic receiver 230. AUVs 220 useful in embodiments will have sufficient weight in water to couple to the floor of the aquatic environment and allow acquisition of seismic data.

In some embodiments, the propulsion system 232 may include one or motors coupled to one or more propellers. The motors may be electrically coupled to the power supply 240, such as an electric battery. In embodiments, the AUV 220 may further include stabilizing fins and/or wings for guiding the AUV 220 to the desired position, which may be used together with the propeller for steering the AUV 220. In embodiments, the AUV 220 may also include a buoyancy system for controlling the depth of the AUV 220 and keeping the AUV 220 steady after contacting the seafloor 214 (FIG. 2).

In embodiments, the communication system 236 may include a communication device such as Wi-Fi device, or a device that uses an acoustic link, or another data transfer device capable of transmitting and receiving data wirelessly or through a wired link. In embodiments, the communication system 236 may further include an antenna, which may be flush with the body of the AUV 220, and a corresponding acoustic system 238 for communicating with, for example, a recovery vessel, the surface vessel 260 (FIG. 2), or the underwater ROV 264 (FIG. 2). An example acoustic system 238 includes an Ultra-Short Base Line (USBL) system, sometimes known as a Super Short Base Line (SSBL), which may be used to determine the location of the AUV 220 relative to the surface vessel 260, as well as communicate data to and from the AUV 220.

In embodiments, the navigation system 234 may include, for example, an inertial navigation system, a compass, a gyroscope, an accelerometer, a depth gauge, a pressure gauge, magnetometer, or other motion sensing devices.

Embodiments disclosed herein include:

A. A method includes drilling a borehole in a seafloor with a drill bit coupled to an end of a drill string extended from a drilling rig, emitting seismic energy from the drill bit as the drill bit advances to extend the borehole, deploying a plurality of autonomous underwater vehicles (AUVs) on the seafloor in a first geometry relative to the borehole, each AUV including a seismic receiver, and receiving the seismic energy emitted from the drill bit with the seismic receiver of each AUV.

B. A method includes drilling a borehole in a seafloor with a drill bit coupled to an end of a drill string extended from a drilling rig, emitting seismic energy from the drill bit as the drill bit advances to extend the borehole, deploying a plurality of autonomous underwater vehicles (AUVs) on the seafloor in a walkaway geometry relative to the borehole, each AUV including a seismic receiver, receiving the seismic energy emitted from the drill bit with the seismic receiver of each AUV, recording seismic data corresponding to the seismic energy received by each seismic receiver while the plurality of AUVs are in the walkaway geometry, retrieving and analyzing the seismic data from the plurality of AUVs, determining a walkaround geometry for the plurality of AUVs based on an analysis of the seismic data from the plurality of AUVs recorded while in the walkaway geometry, deploying the plurality of AUVs on the seafloor in the walkaround geometry, and receiving the seismic energy emitted from the drill bit with the seismic receiver of each AUV while the plurality of AUVs are in the walkaround geometry.

C. A system includes a drilling rig having a drill bit coupled to a distal end of a drill string configured to drill a borehole in a seafloor, and a plurality of AUVs each having a seismic receiver, the plurality of AUVs being configured to contact the seafloor and receive seismic data from the drill bit while drilling a borehole.

Each of embodiments A, B, and C may have one or more of the following additional elements in any combination: Element 1: wherein the first geometry results in the plurality of AUVs being deployed relative to the borehole in one of a zero-offset geometry, a walkaway geometry, a walk around geometry, or a 3 dimensional seismic while drilling geometry. Element 2: further comprising recording seismic data corresponding to the seismic energy received by each seismic receiver and retrieving the seismic data from the plurality of AUVs. Element 3: further comprising deploying the plurality of AUVs on the seafloor in a second geometry different from the first geometry, and receiving the seismic energy emitted from the drill bit with each seismic receiver while in the second geometry. Element 4: further comprising recording seismic data corresponding to the seismic energy received by the seismic receiver of each AUV while the plurality of AUVs are in the first geometry, retrieving and analyzing the seismic data from the plurality of AUVs, and determining the second geometry based on an analysis of the seismic data from the plurality of AUVs recorded while in the first geometry. Element 5: further comprising receiving vibration energy emitted from the drill string with a top drive sensor coupled to a top drive included in the drilling rig, recording vibration data corresponding to the vibration energy, and deconvolving the vibration energy from the seismic data. Element 6: wherein the retrieving the seismic data includes recovering the plurality of AUVs from the seafloor, and downloading the seismic data from the plurality of AUVs. Element 7: wherein the first geometry comprises a walkaway geometry and deploying the plurality of AUVs on the seafloor in the second geometry comprises deploying the plurality of AUVs on the seafloor in a first walkaround geometry having a first radius relative to the borehole. Element 8: further comprising deploying the plurality of AUVs on the seafloor in a second walk around geometry having a second radius relative to the borehole, wherein the second radius is different from the first radius. Element 9: wherein the walkaway geometry results in the plurality of AUVs being deployed in a generally linear geometry that transects the borehole, and the first walk around geometry results in the plurality of AUVs being deployed in a generally circular geometry concentric with the borehole. Element 10: wherein deploying the plurality AUVs on the seafloor includes lowering a basket from a surface vessel, the plurality of AUVs being arranged within the basket, and launching the plurality of AUVs from the basket. Element 11: further comprising deploying an underwater remote operated vehicle (ROV) from the surface vessel to undertake one or more of controlling movement of the plurality of AUVs from the basket to the seafloor, controlling movement of the plurality of AUVs from the seafloor to the basket, controlling movement of the plurality of AUVs from the first geometry to a second geometry, and retrieving data from the plurality of AUVs.

Element 12: wherein the walkaround geometry is a first walkaround geometry with the plurality of AUVs being arranged concentric with the borehole at a first radius relative to the borehole, the method further comprising continuing drilling the borehole until reaching a target reservoir, and deploying the plurality of AUVs on the seafloor in a second walkaround geometry having a second radius relative to the borehole, wherein the second radius is different from the first radius. Element 13: further comprising receiving vibration energy emitted from the drill string with a top-drive sensor coupled to a top drive included in the drilling rig, recording vibration data corresponding to the vibration energy, and deconvolving the vibration energy from the seismic data. Element 14: wherein the deploying steps include lowering a basket from a surface vessel, the plurality of AUVs being arranged in the basket, and launching the plurality of AUVs from the basket. Element 15: further comprising deploying an underwater remote operated vehicle (ROV) from the surface vessel to undertake one or more of controlling movement of the plurality of AUVs from the basket to the seafloor, controlling movement of the plurality of AUVs from the seafloor to the basket, controlling movement of the plurality of AUVs from the first geometry to a second geometry, and retrieving data from the plurality of AUVs.

Element 17: further comprising a surface vessel having a basket configured to lower the plurality of AUVs toward the seafloor. Element 18: further comprising an ROV configured to undertake one or more of controlling the movement of the plurality of AUVs from the basket to the seafloor, controlling the movement of the plurality of AUVs from the seafloor to the basket, controlling the movement of the plurality of AUVs from a first geometry to a second geometry, and retrieving data from the plurality of AUVs.

By way of non-limiting example, exemplary combinations applicable to A, B, and C include: Element 3 with Element 4; Element 4 with Element 5; Element 4 with Element 6; Element 3 with Element 7; Element 7 with Element 8; Element 7 with Element 9; Element 10 with Element 11; Element 14 with Element 15; and Element 17 with Element 18.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or an indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method, comprising:
drilling a borehole in a seafloor with a drill bit coupled to an end of a drill string extended from a drilling rig;
emitting seismic energy from the drill bit as the drill bit advances to extend the borehole;
deploying a plurality of autonomous underwater vehicles (AUVs) on the seafloor in a first geometry relative to the borehole, each AUV including a seismic receiver; and
receiving the seismic energy emitted from the drill bit with the seismic receiver of each AUV.

2. The method of claim 1, wherein the first geometry results in the plurality of AUVs being deployed relative to the borehole in one of a zero-offset geometry, a walkaway geometry, a walk around geometry, or a 3 dimensional seismic while drilling geometry.

3. The method of claim 1, further comprising recording seismic data corresponding to the seismic energy received by each seismic receiver and retrieving the seismic data from the plurality of AUVs.

4. The method of claim 1, further comprising:
deploying the plurality of AUVs on the seafloor in a second geometry different from the first geometry; and
receiving the seismic energy emitted from the drill bit with each seismic receiver while in the second geometry.

5. The method of claim 4, further comprising:
recording seismic data corresponding to the seismic energy received by the seismic receiver of each AUV while the plurality of AUVs are in the first geometry;
retrieving and analyzing the seismic data from the plurality of AUVs; and
determining the second geometry based on an analysis of the seismic data from the plurality of AUVs recorded while in the first geometry.

6. The method of claim 5, further comprising:
receiving vibration energy emitted from the drill string with a top drive sensor coupled to a top drive included in the drilling rig;
recording vibration data corresponding to the vibration energy; and
deconvolving the vibration energy from the seismic data.

7. The method of claim 5, wherein the retrieving the seismic data includes:
recovering the plurality of AUVs from the seafloor; and
downloading the seismic data from the plurality of AUVs.

8. The method of claim 4, wherein the first geometry comprises a walkaway geometry and deploying the plurality of AUVs on the seafloor in the second geometry comprises deploying the plurality of AUVs on the seafloor in a first walkaround geometry having a first radius relative to the borehole.

9. The method of claim 8, further comprising deploying the plurality of AUVs on the seafloor in a second walk around geometry having a second radius relative to the borehole, wherein the second radius is different from the first radius.

10. The method of claim 8, wherein the walkaway geometry results in the plurality of AUVs being deployed in a generally linear geometry that transects the borehole, and the first walk around geometry results in the plurality of AUVs being deployed in a generally circular geometry concentric with the borehole.

11. The method of claim 1, wherein deploying the plurality AUVs on the seafloor includes:
lowering a basket from a surface vessel, the plurality of AUVs being arranged within the basket; and
launching the plurality of AUVs from the basket.

12. The method of claim 11, further comprising deploying an underwater remote operated vehicle (ROV) from the surface vessel to undertake one or more of:
controlling movement of the plurality of AUVs from the basket to the seafloor;
controlling movement of the plurality of AUVs from the seafloor to the basket;
controlling movement of the plurality of AUVs from the first geometry to a second geometry; and
retrieving data from the plurality of AUVs.

13. A method, comprising:
drilling a borehole in a seafloor with a drill bit coupled to an end of a drill string extended from a drilling rig;
emitting seismic energy from the drill bit as the drill bit advances to extend the borehole;
deploying a plurality of autonomous underwater vehicles (AUVs) on the seafloor in a walkaway geometry relative to the borehole, each AUV including a seismic receiver;
receiving the seismic energy emitted from the drill bit with the seismic receiver of each AUV;
recording seismic data corresponding to the seismic energy received by each seismic receiver while the plurality of AUVs are in the walkaway geometry;
retrieving and analyzing the seismic data from the plurality of AUVs;
determining a walkaround geometry for the plurality of AUVs based on an analysis of the seismic data from the plurality of AUVs recorded while in the walkaway geometry;
deploying the plurality of AUVs on the seafloor in the walkaround geometry; and
receiving the seismic energy emitted from the drill bit with the seismic receiver of each AUV while the plurality of AUVs are in the walkaround geometry.

14. The method of claim 13, wherein the walkaround geometry is a first walkaround geometry with the plurality of AUVs being arranged concentric with the borehole at a first radius relative to the borehole, the method further comprising:
continuing drilling the borehole until reaching a target reservoir; and
deploying the plurality of AUVs on the seafloor in a second walkaround geometry having a second radius relative to the borehole, wherein the second radius is different from the first radius.

15. The method of claim 13, further comprising:
receiving vibration energy emitted from the drill string with a top-drive sensor coupled to a top drive included in the drilling rig;
recording vibration data corresponding to the vibration energy; and
deconvolving the vibration energy from the seismic data.

16. The method of claim 13, wherein the deploying steps include:
lowering a basket from a surface vessel, the plurality of AUVs being arranged in the basket; and
launching the plurality of AUVs from the basket.

17. The method of claim 16, further comprising deploying an underwater remote operated vehicle (ROV) from the surface vessel to undertake one or more of:
controlling movement of the plurality of AUVs from the basket to the seafloor;
controlling movement of the plurality of AUVs from the seafloor to the basket;
controlling movement of the plurality of AUVs from the first geometry to a second geometry; and
retrieving data from the plurality of AUVs.

18. A system, comprising:
a drilling rig having a drill bit coupled to a distal end of a drill string configured to drill a borehole in a seafloor; and
a plurality of AUVs each having a seismic receiver, the plurality of AUVs being configured to contact the seafloor and receive seismic data from the drill bit while drilling a borehole.

19. The system of claim 16, further comprising a surface vessel having a basket configured to lower the plurality of AUVs toward the seafloor.

20. The system of claim 19, further comprising an ROV configured to undertake one or more of:
controlling the movement of the plurality of AUVs from the basket to the seafloor;
controlling the movement of the plurality of AUVs from the seafloor to the basket;
controlling the movement of the plurality of AUVs from a first geometry to a second geometry; and
retrieving data from the plurality of AUVs.
